(19) United States
(12) Patent Application Publication
(10) Pub. No.: US 2016/0207822 A1
(43) Pub. Date: Jul. 21, 2016

(54) GLASS SUBSTRATE PRODUCTION MANAGEMENT SYSTEM AND GLASS SUBSTRATE PRODUCTION MANAGEMENT METHOD

(71) Applicant: Nippon Electric Glass Co., Ltd., Shiga (JP)

(72) Inventor: Shinji OHIGASHI, Shiga (JP)

(73) Assignee: Nippon Electric Glass Co., Ltd., Shiga (JP)

(21) Appl. No.: 14/914,058

(22) PCT Filed: Aug. 20, 2014
(86) PCT No.: PCT/JP2014/071722

§ 371 Date: Feb. 24, 2016

(30) Foreign Application Priority Data
Aug. 27, 2013 (JP) 2013-175391

(51) Int. Cl. C03B 33/037; G01N 21/88; G01N 21/958

(52) U.S. Cl. CPC C03B 33/037; G01N 21/958; G01N 21/8851; G01N 2021/8858

(57) ABSTRACT

Provided is a glass substrate production management system, including: a first inspection part (A) for calculating a lot average defect density; a preliminary calculation part (B) for preliminarily calculating an allowable number of defects; a second inspection part (C) for performing an inspection on all the multi-sheet production glass substrates; and a defect determination part (D) for determining whether the multi-sheet production glass substrates (1) are non-defective or defective.

### TECHNICAL FIELD

The present invention relates to a system for managing production of glass substrates and a method of managing production of glass substrates, and more specifically, to a system for managing production of glass substrates and a method of managing production of glass substrates, involving a procedure of performing a product-related process on a multi-sheet production glass substrate having a plurality of virtual individual surfaces, which, is manufactured in an upstream-side step, to thereby divide the multi-sheet production glass substrate into a plurality of individual-surface glass sheets in a downstream-side step.

### BACKGROUND ART

As is well known, glass substrates used for flat panel displays (hereinafter also referred to as “FFDs”) such as plasma displays, liquid-crystal displays, field-emission displays (including surface-emission displays), electroluminescence displays, and OLED displays, glass substrates used for OLED lightings, glass substrates used for tempered glass that is a component of a touch panel or the like, and glass substrates used for solar cell panels or other electronic devices nave been promoted to be used as so-called “multi-sheet production glass substrates” for a purpose of productivity improvement and the like in actual conditions.

For the above-mentioned types of multi-sheet production glass substrates, pieces of mother glass are sequentially manufactured one by one as an uppermost-stream side process. As a downstream-side process, the mother glass is cut to be divided into a plurality of individual-surface glass sheets or the mother glass is: divided into a plurality of individual-surface glass sheets after a product-related process such as formation of a film or circuit patterns corresponding to a plurality of display screens is performed on a surface of the mother glass.

In this case, hitherto, apluraiifcy of virtual individual surfaces of the multi-sheet production glass substrate are required to have no defect at any location. Therefore, along with increase in size of the multi-sheet production glass substrate, a product yield is greatly lowered. Therefore, there is a problem in that costs inevitably run up.

In order to cope with the problem described above, for example, in Patent Literature 1, there is disclosed elimination of loss in a process from the upstream—side step to the downstream-side step by treating a multi-sheet production glass substrate having a defect in a specific portion as a non-defective product.

Specifically, for example, when the number of virtual individual surfaces is four, in order to prevent the entire multi-sheet production glass substrate for the four surfaces from becoming loss only due to a defect on one surface thereof, defect information such as a position, a type, and a size of the defect for each multi-sheet production glass substrate is conveyed from an operator in the upstream-side step to an operator in the downstream-side step so that the virtual individual, surface having a serious defect is discarded as a defective individual-surface glass sheet after cutting.

### CITATION LIST

Patent Literature 1: JP 4347067 B2

### SUMMARY OF INVENTION

### Technical Problem

However, the technology disclosed in Patent literature 1 requires an investigation and a facility for a method of conveying the defect information from the operator in the upstream-side step to the operator in the downstream-side step. Further, complication of inventory control and complication of production scheduling for products due to execution of the method become remarkable. Hence, there is a problem in that practical application thereof becomes difficult.

In addition, the technology disclosed in Patent Literature 1 merely discards the individual-surface glass sheet that has been subjected to the product-related process in the downstream-side step based on the defect information conveyed from the upstream-side step to the downstream-side step. Therefore, whether or not the operator in the downstream-side step suffers a significant loss is unknown. As a result, there is also a problem in that the operator in the downstream-side step suffers an extremely large loss.

The present invention has been made in view of the circumstances described above and has an object to provide a system for managing production of glass, substrates and a method of managing production of glass substrates, which eliminate need of conveyance of defect information of each multi-sheet production glass substrate from an upstream-side step to a downstream-side step, simplify inspection of defects to improve operating efficiency, and take into consideration total profit and loss for an operator in the upstream-side step and an operator in the downstream-side step.

### Solution To Problem

According to a first aspect of the present invention devised in order to achieve the above-mentioned object, there is provided a system for managing production of glass substrates, the system comprising a procedure of performing a product-related process on multi-sheet production glass substrates manufactured in an upstream-side step to divide each of the multi-sheet production glass substrates into a plurality of individual-surface glass sheets in a downstream-side step, the system comprising: a first inspection part configured to detect a total number of defects present in ten or more multi-sheet production glass substrates sampled from one lot of ten or more multi-sheet production glass substrates in the upstream-side step based on defect data of a defect inspection performed on the sampled multi-sheet production glass substrates, and for calculating a lot average defect density obtained-by dividing the total number of defects by a total area of the multi-sheet production glass substrates as targets to be inspected; a preliminary calculation part configured to preliminarily calculate, for the one lot of the multi-sheet production glass substrates in the upstream-side step, a profit received by an operator in the upstream-side step by preliminarily regarding the each of the multi-sheet production glass substrates having the defect as a non-defective product and sending the each of the multi-sheet production glass substrates having the defect to the downstream-side step, and a loss suffered by an operator in the downstream-side step due to occurrence of a defective product caused by presence of the defect when the each of the multi-sheet production glass substrates preliminarily regarded as the non-defective product is divided into the plurality of individual-surface glass sheets after being subjected to the product-related process, over a plurality of times by using the lot average defect density while differing a number of the defects present in the single multi-sheet production glass substrate, and for calculating an allowable number of defects indicating an appropriate number of the defects present in the single multi-sheet production glass substrate based on results of the preliminary calculations when the profit is larger than the loss; a second inspection part configured to perform a defect inspection on ail line multi-sheet, production glass substrates of the one lot in the upstream-side step to count an actual number of the defects present in the single multi-sheet production glass substrate; and a defect determination part configured to determine the multi-sheet production glass substrates in which the actual number of the defects present in the single multi-sheet production glass substrate fails within a range of the allowable number of defects calculated by the preliminary calculation part as non-defective products to be sent to the downstream-side step in addition to the multi-sheet production glass substrates with no defect, and for determining other multi-sheet production glass substrates as defective products to be discarded in the upstream-side step.

Here, the “profit received by the operator in the upstream-side step” in the preliminary calculation part described above is a profit that can be obtained in comparison with a related-art system in which the multi-sheet production glass substrate having even at least one defect is discarded. The “loss suffered by the operator in the downstream-side step” in the preliminary calculation part described above is a loss that is generated in comparison with a case where ail the individual-surface glass sheets obtained by performing the product-related process on the multi-sheet production glass substrate to divide the multi-sheet production glass substrate are non-defective: products because of the absence of the defect caused in the upstream-side step over the entire surface of the multi-sheet production glass substrate sent from the upstream-side step to the downstream-side step in the related-art system. The “product-related process” is a process of, for example, forming a film or a circuit pattern corresponding to a display screen on a surface of the multi-sheet production glass substrate.

According to the configuration described above, at the time of completion of or in a process of manufacture of the one lot of ten or more multi-sheet production glass substrates after the operator in the upstream-side step uses a forming apparatus or the like to sequentially manufacture the multi-sheet production glass substrates each having a rectangular shape, the first inspection part counts the number of defects present in the entire surface of the each multi-sheet multi-sheet production glass substrates based on the defect data obtained by the defect inspection, and calculates the lot average defect density of a group of the multi-sheet production glass substrates, which is obtained by dividing a total number of defects by an inspected total area. Subsequently, the preliminary calculation part preliminarily calculates the profit received by the operator in the upstream-side step and the loss suffered by the operator in the downstream-side step over a plurality of times while sequentially differing the number of the defects present in the single multi-sheet production glass substrate to calculate the allowable number of defects, which is an appropriate number of the defects present in the single multi-sheet production glass substrate, when the above-mentioned profit is larger than the above-mentioned loss. For the calculation, the profit received by the operator in the upstream-side step is obtained based on a unit price per multi-sheet production glass substrate in the upstream-side step and a yield (proportion of non-defective products) of the multi-sheet production glass substrates with the number of the defects present in the single multi-sheet production glass substrate falls within the allowable number of defects, the yield being calculated based on the lot average defect density. Further, the loss suffered by the operator in the downstream-side step is obtained based on a unit price per individual-surface glass sheet when the multi-sheet production glass substrate is subjected to the product-related process and is divided into the plurality of individual-surface glass sheets in the downstream-side step and a rate of defective products due to the defects contained in the individual-surface glass sheets after the division in the downstream-side step as a result of the delivery of the multi-sheet production glass substrates including the virtual individual surfaces each having the defect, to the downstream-side step so as to correspond to the allowable number of defects the rate being calculated based on the lot average defect density. Thereafter, the defect determination part regards the multi-sheet production glass substrate as a non-defective product and sends the multi-sheet production glass substrate to the downstream-side step together with the multi-sheet production glass, substrate with no defect when the actual number of the defects actually present in the single multi-sheet production glass substrate is the allowable number of defects calculated by the preliminary calculation part, and discards other multi-sheet production glass substrates as the defective product in the upstream-side step after the second inspection part counts the actual number of the defects present in the single multi-sheet production glass substrate for all the multi-sheet production glass substrates of the one lot. As a result, the profit received by the operator in the upstream-side step and the loss suffered from the operator in the downstream-side step yield a profit when considered in total. Therefore, when the profit is distributed to both of the operators, both of the operators can obtain a profit. By the operation described above, whether the multi-sheet production glass substrate is non-defective or defective can be determined only in the upstream-side step completely independently of the downstream-side step. Correspondingly, the defect information is not required to be conveyed from the operator in the upstream-side step to the operator in the downstream-side step. Thus, advantages are provided in terms of facility, inventory control, and production scheduling for products. Thus, an actual operation can be per formed easily. In addition, a careful inspection for defects is not required to be performed in the upstream-side step, and inspection work for defects is remarkably simplified to improve operating efficiency. In addition, whether the multi-sheet production glass substrate is a non-defective product or a defective product can be determined by considering the profit and loss of the operator in the upstream-side step and the operator in the downstream-side step in total. Therefore, there are no adverse effects such as unreasonable loss suffered by only the operator in the upstream-side step or the operator in the downstream-side step.

According to a second aspect of the present invention devised in order to achieve the above-mentioned object, there is provided a system for managing production of glass substrates, comprising a procedure of performing a product-related process on multi-sheet production glass substrates manufactured in an upstream-side step to divide each of the multi-sheet production glass substrates into a plurality of individual-surface glass sheets in a downstream-side step, the glass substrate production management system comprising: an inspection part configured, to detect a total number of defects present in ten or more multi-sheet production glass substrates sampled from one lot of ten or more multi-sheet production glass substrates in the upstream-side step based on defect data of a defect inspection performed on the sampled multi-sheet production glass substrates, to thereby calculate a lot average defect density obtained by dividing the total number of defects by a total area of the multi-sheet production glass substrates as targets to be inspected, and for performing a defect inspection on all the multi-sheet production glass substrates of the one lot to count an actual number of the defects present in the single multi-sheet production glass substrate; a preliminary calculation part configured to preliminarily calculate, for the one lot of the multi-sheet production glass substrates in the upstream-side step, a profit received by an operator in the upstream-side step by preliminarily regarding the each of the multi-sheet production glass substrates having the defect as a non-defective product and sending the each of the multi-sheet production glass substrates having the defect to the downstream-side step, and a loss suffered by an operator in the downstream-side step due to occurrence of a defective product caused by presence of the defect when the each of the multi-sheet production glass substrates preliminarily regarded as the non-defective product is divided into the plurality of individual-surface glass sheets after being subjected to the product-related process, over a plurality of times by using the lot average defect density while differing a number of the defects present in the single multi-sheet production glass substrate, and for calculating an allowable number of defects indicating an appropriate number of the defects present in the single multi-sheet production glass substrate when the profit is larger than the loss; and a defect determination part configured to determine the multi-sheet production glass substrates in which the actual number of the defects present in the single multi-sheet production glass substrate calculated by the inspection part fails within a range of the allowable number of defects calculated by the preliminary calculation part as non-defective products to be sent to the downstream-side step in addition to the multi-sheet production glass substrates with no defect, and for determining other multi-sheet production glass substrates as defective products to be discarded in the upstream-side step.

The second aspect of the invention differs from the first aspect of the invention described above in that the calculation of the lot average defect density and the counting of the actual number of the defects present in the single multi-sheet production glass substrate for all the multi-sheet production glass substrates of the one lot each having the defect are performed simultaneously by the single inspection part. The remaining configuration is the same. Thus, the description of operations or functions and effects thereof is herein omitted.

In the first and second aspects of the present invention, a surface of the each of the multi-sheet production glass substrates to be subjected to the product-related process in the downstream-side step is divided into a harmful region, in which the defect is harmful to the product-related process, and a harmless region, in which the defect is harmless to the product-related process, to obtain, as a harmless-region relief rate, a value by dividing an area of the harmless region by an area of the each of the multi-sheet production glass substrates, and the harmless-region relief rate can be used for the calculations performed by the preliminary calculation part.

In this manner, even if the virtual individual surface has the defect, the virtual individual surface is not regarded as defective in the downstream-side step when the defect is present in the harmless region, which matches an actual condition. Therefore, accuracy of calculations by the preliminary calculation part becomes higher.

In the configuration described above, the operator in the upstream-side step may be a manufacturer of mother glass as the each of the multi-sheet production glass substrates for a flat panel display, and the operator in the downstream-side step may be an intermediate or final manufacturer of a panel for the fiat panel display.

In this manner, when the operator in the upstream-side step sequentially manufactures pieces of mother glass each having a rectangular shape by a downdraw method or a float method and then the above-mentioned operation is performed, the number of defects can be estimated for the mother glass that is ultimately treated as a non-defective product. Then, the manufacturer of the panels excludes the non-defective products by performing a regular inspection. As a result, a gain is obtained when both of a profit and a loss for the manufacturer of the mother glass and the manufacturer of the panels are considered in total.

Further, the operator in the upstream-side step may be a manufacturer of mother glass as the each of the multi-sheet production glass substrates for a flat panel display, and the operator in the downstream-side step may be a manufacturer who cuts and processes the mother glass for the flat panel display into the individual-surface glass sheets.

Even in this case, the same advantages as those in the case described immediately above can be obtained.

Further, it is preferred that the calculating in the preliminary calculation part and the determining in the defect determination part be performed by a computer.

In this manner, complex and required calculations and the like are automated, and a system capable of performing a rapid process is realized.

According to a third aspect of the present invention devised in order to achieve the above-mentioned object, there is provided a method of managing production of glass substrates, comprising a procedure of performing a product-related process on multi-sheet production glass substrates manufactured in an upstream-side step to divide each of the multi-sheet production glass substrates into a plurality of individual-surface glass sheets in a downstream-side step, the method comprising: a first inspection step of detecting a total number of defects present in ten or more multi-sheet production glass substrates sampled from one lot of ten or more multi-sheet production glass substrates in the upstream-side step based on defect data of a defect inspection performed on the sampled multi-sheet production glass substrates, and for calculating a lot average defect density obtained by dividing the total number of defects by a total area of the multi-sheet production glass substrates as targets to be inspected; a preliminary calculation step of preliminarily calculating, for the one lot of the multi-sheet production glass substrates in the upstream-side step, a profit received by an operator in the upstream-side step by preliminarily regarding the each of the multi-sheet production glass substrates having the defect as a non-defective product and sending the each of the multi-sheet production glass substrates having the defect to the downstream-side step, and a loss suffered by an operator in the downstream-side step due to occurrence of a defective product caused by presence of the defect when the each of the multi-sheet production glass substrates preliminarily regarded as the non-defective product is divided into the plurality of individual-surface glass sheets after being subjected to the product-related process, over a plurality of times by using the lot average defect density while differing a number of the defects present in the single multi-sheet production glass substrate, and for calculating an allowable number of defects indicating an appropriate number of the defects present in the single multi-sheet production glass substrate based on results of the preliminary calculations when the profit is larger than the loss; a second inspection step of performing a defect inspection on all the multi-sheet production glass substrates of the one lot in the upstream-side step to count an actual number of the defects present in the single multi-sheet production glass substrate; and defect a determination step of determining the multi-sheet production glass substrates in which the actual number of the defects present in the single multi-sheet production glass substrate falls within a range of the allowable number of defects calculated by the preliminary calculation step as non-defective products to be sent to the downstream-side step in addition to the multi-sheet production glass substrates with no defect, and for determining other multi-sheet production glass substrates as defective products to be discarded in the upstream-side step.

The third aspect of the invention relates to the method of managing production of glass substrates. Actual operations or functions and effects are the same as those of the system for managing production of glass substrates according to the first aspect of the invention described above. Therefore, the description thereof is herein omitted.

According to a fourth aspect of the present invention devised in order to achieve the above-mentioned object, there is provided a method of managing production of glass substrates, comprising a procedure of performing a product-related process on multi-sheet production glass substrates manufactured in an upstream-side step to divide each of the multi-sheet production glass substrates into a plurality of individual-surface glass sheets in a downstream-side step, the method comprising: an inspection step of detecting a total number of defects present in ten or more multi-sheet production glass substrates sampled from one lot of ten or more multi-sheet production glass substrates in the upstream-side step based on defect data of a defect inspection performed on the sampled multi-sheet production glass substrates, to thereby calculate a lot average defect density obtained by dividing the total number of defects by a total area of the multi-sheet production glass substrates as targets to be inspected, and for performing a defect inspection on all the multi-sheet production glass substrates of the one lot to count an actual number of the defects present in the single multi-sheet production glass substrate; a preliminary calculation step of preliminarily calculating, for the one lot of the multi-sheet production glass substrates in the upstream-side step, a profit received by an operator in the upstream-side step by preliminarily regarding the each of the multi-sheet production glass substrates having the defect as a non-defective product and sending the each of the multi-sheet production glass substrates having the defect to the downstream-side step, and a loss suffered toy an operator in the downstream-side step due to occurrence of a defective product caused by presence of the defect when the each of the multi-sheet production glass substrates preliminarily regarded as the non-defective product is divided into the plurality of individual-surface glass sheets after being subjected to the product-related process, over a plurality of times by using the lot average defect density while differing a number of the defects present in the single multi-sheet production glass substrate, and for calculating an allowable number of defects indicating an appropriate number of the defects present in the single multi-sheet production glass substrate when the profit is larger than the loss; and a defect determination step of determining the multi-sheet production glass substrates in which the actual number of the defects present in the single multi-sheet production glass substrate calculated in the inspection step fails within a range of the allowable number of defects calculated by the preliminary calculation step as non-defective products to be sent to the downstream-side step in addition to the multi-sheet production glass substrates with no defect, and for determining other multi-sheet production glass substrates as defective products to be discarded in the upstream-side step.

The fourth aspect of the invention relates to the method of managing production of glass substrates. Actual operations or functions and effects are the same as those of the system fox managing production of glass substrates according to the second aspect of the invention described above. Therefore, the description thereof is herein omitted.

In this case, also in the third and fourth aspects of the invention described above, the method may further comprise dividing a surface of the each of the multi-sheet production glass substrates to be subjected to the product-related process in the downstream-side step into a harmful region, in which the defect is harmful to the product-related process, and a harmless region, in which the defect is harmless to the product-related process, to obtain, as a harmless-region relief rate, a value by dividing an area of the harmless region by an area of the each of the multi-sheet production glass substrates, and using the harmless-region relief rate for the calculations performed by the preliminary calculation part (preliminary calculation step). Further, the operator in the upstream-side step may be a manufacturer of mother glass as the each of the multi-sheet production glass substrates for a fiat panel display, and the operator in the downstream-side step may be an intermediate or final manufacturer of a panel for the flat panel display. Alternatively, the operator in the upstream-side step may be a manufacturer of mother glass as the each of the multi-sheet production glass substrates for a fiat panel display, and the operator in the downstream-side step may be a manufacturer who cuts and processes the mother glass for the flat panel display into the individual-surface glass sheets. Further, the preliminary calculation step and the defect determination step may be performed by a computer.

### ADVANTAGEOUS EFFECTS OF INVENTION

According to the aspects of the present invention as described above, it is possible to realize the system for managing production of glass substrates and the method of managing production of glass substrates, which eliminate the need of conveyance of defect information of multi-sheet production glass substrates from the upstream-side step to the downstream-side step, simplify the inspection of defects to improve the operating efficiency, and take into consideration the total profit and loss for the operator in the upstream-side step and the operator in the downstream-side step.

### BRIEF DESCRIPTION OF DRAWINGS

FIG. 1 is a schematic configuration diagram for illustrating a main configuration of a system for managing production of glass substrates according to an embodiment of the present invention.

FIG. 2 is a flowchart for illustrating a procedure of the system for managing production of glass substrates according to the embodiment of the present invention.

FIG. 3a is a schematic view for illustrating a process of manufacturing individual-surface glass sheets in practice by using the system for managing production of glass substrates according to the embodiment of the present invention.

FIG. 3b is a schematic view for illustrating the process of manufacturing individual-surface glass sheets in practice by using the system for managing production of glass substrates according to the embodiment of the present invention.

FIG. 3c is a schematic view for illustrating the process of manufacturing individual-surface glass sheets in practice by using the system for managing production of glass substrates according to the embodiment of the present invention.

FIG. 4a is a schematic view for illustrating the process of manufacturing individual-surface glass sheets in practice by using the system for managing production of glass substrates according to the embodiment of the present invention.

FIG. 4b is a schematic view for illustrating the process or manufacturing individual-surface glass sheets in practice by using the system for managing production of glass substrates according to the embodiment of the present invention.

FIG. 4c is a schematic view for illustrating the process of manufacturing individual surface glass sheets in practice by using the system for managing production of glass substrates according to the embodiment of the present invention.

FIG. 5a is a schematic view for illustrating the process of manufacturing individual-surface glass sheets in practice by using the system for managing production of glass substrates according to the embodiment of the present invention.

FIG. 5b is a schematic view for illustrating the process of manufacturing individual-surface glass sheets in practice by using the system for managing production of glass substrates according to the embodiment of the present invention.

FIG. 5c is a schematic view for illustrating the process of manufacturing individual-surface glass sheets in practice by using the system for managing production of glass substrates according to the embodiment of the present invention.

FIG. 6a is a schematic view for illustrating the process of manufacturing individual-surface glass sheets in practice by using the system for managing production of glass substrates according to the embodiment of the present invention.

FIG. 6b is a schematic view for illustrating the process of manufacturing individual-surface glass sheets in practice by using the system for managing production of glass substrates according to the embodiment of the present invention.

FIG. 6c is a schematic view for illustrating the process of manufacturing individual surface glass sheets in practice by using the system for managing production of glass substrates according to the embodiment of the present invention.

FIG. 7a is a schematic view for illustrating the process of manufacturing individual-surface glass sheets in practice by using the system for managing production of glass substrates according to the embodiment of the present invention.

FIG. 7b is a schematic view for illustrating the process of manufacturing individual surface glass sheets a practice by using the system for managing production of glass substrates according to the embodiment of the present invention.

FIG. 7c is a schematic view for illustrating the process of manufacturing individual-surface glass sheets in practice by using the system for managing production of glass substrates according to the embodiment of the present invention.

FIG. 8 is a schematic plan view for illustrating a harmless-region relief rate to be used in the system for managing production of glass substrates according to the embodiment of the present invention.

FIG. 9 is a schematic configuration diagram for illustrating a main configuration of a system for managing production of glass substrates according to another embodiment of the present invention.

FIG. 10 is a schematic configuration diagram, for illustrating a main configuration of a method of managing production, of glass substrates according to the embodiment of the present invention.

FIG. 11 is a schematic configuration diagram, for illustrating a main configuration of a method of managing production of glass substrates according to another embodiment of the present invention.

### DESCRIPTION OF EMBODIMENTS

Now, a method for producing glass substrates according to embodiments of the present invention is described referring to the drawings.

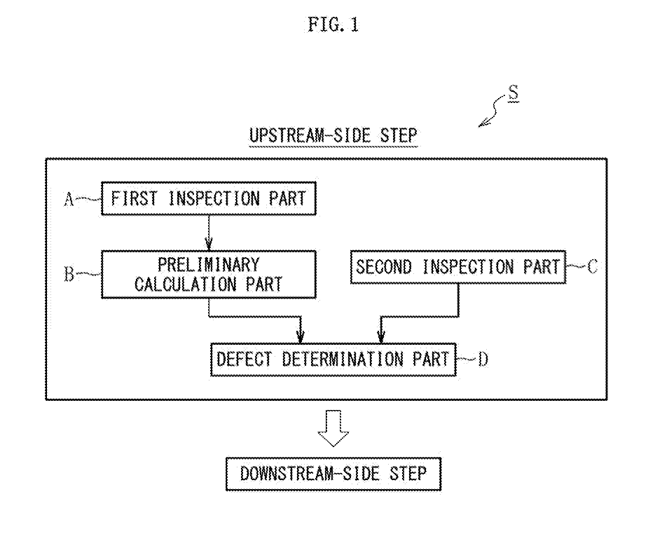

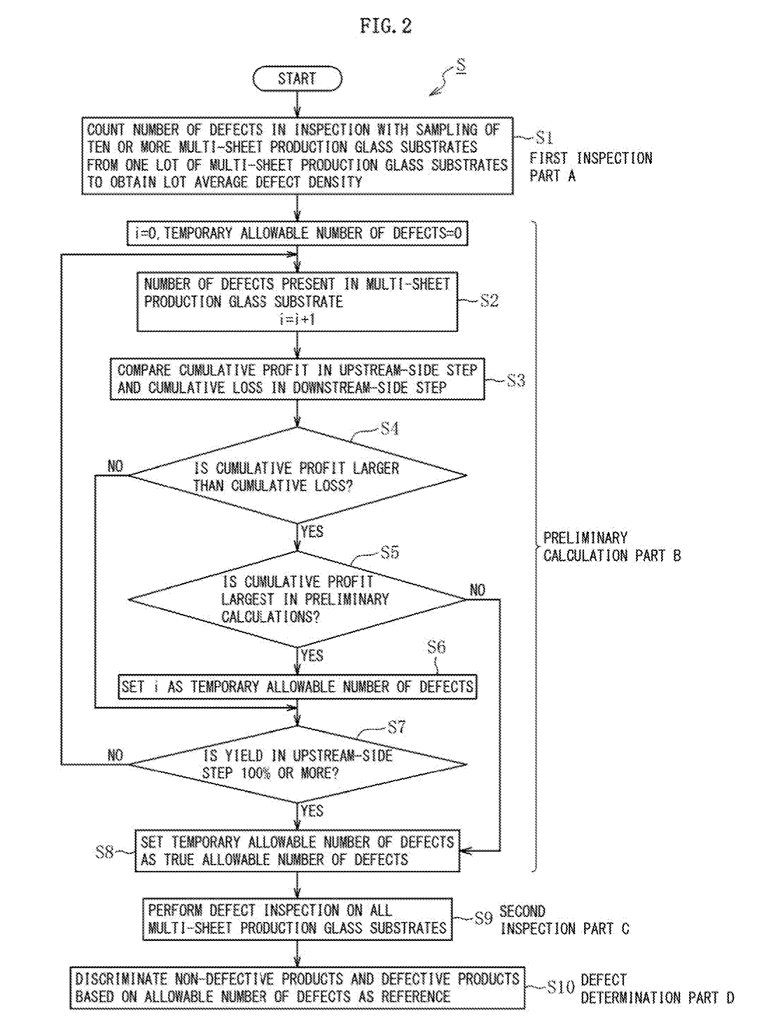

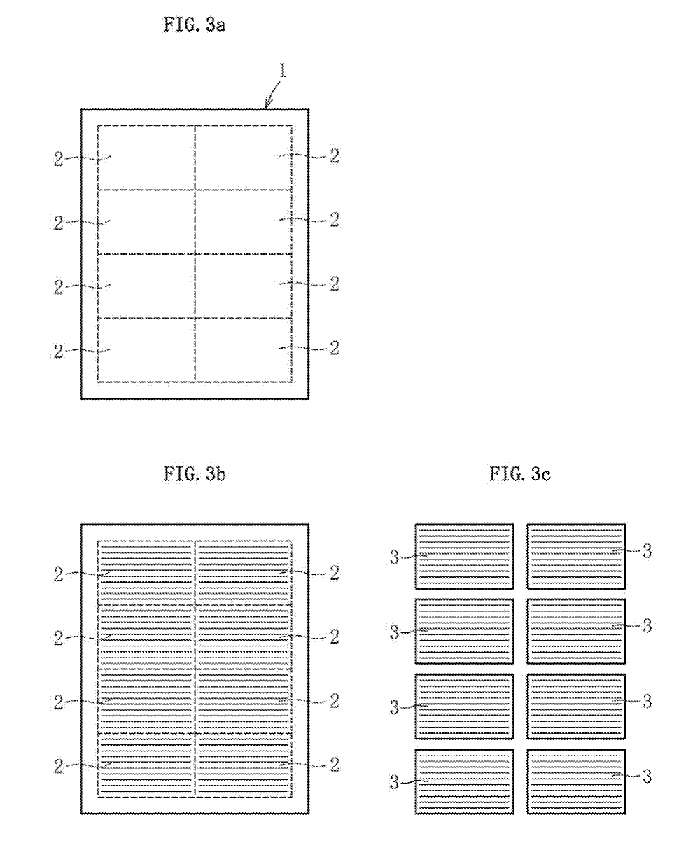

FIG. 1 is a schematic configuration diagram for illustrating a main configuration of a system for managing production of glass substrates (hereinafter referred to simply as “production management system”) according to an embodiment of the present invention. FIG. 2 is a flowchart for illustrating a procedure of the production management system. FIGS. 3 to FIGS. 7 are schematic diagrams for illustrating a state of implementation of the production management system.

First, for convenience, a configuration of a main part

of the production management system in an initial state is described referring to FIGS. 3. As illustrated in FIG. 3 (a), a multi-sheet production glass substrate 1 has a rectangular shape. A region excluding edge portions of tour sides is virtually divided into eight virtual individual, surfaces 2. The multi-sheet production glass substrate 1 is formed by a downdraw method or a float method in an upstream-side step and is cut into a predetermined size (for example, a horizontal dimension of from 1,400 mm to 2,600 mm; and a vertical dimension of from 1,600 mm to 2,800 mm). FIG. 3 (b) is an illustration of a state after all the Virtual individual surfaces 2 of the multi-sheet production glass substrate 1 are subjected to a process such as formation of a film: or a circuit pattern in a downstream-side seep, and FIG. 3(c) is an illustration of a state after processed virtual individual surfaces are respectively divided into individual-surface glass sheets 3 in the downstream-side step.

Next, a configuration of the production management system according to this embodiment is described referring to FIG. 1. A production management system S comprises a first inspection part A to be operated through sampling from one lot of ten or more multi-sheet production glass substrates 1 in the upstream-side step, a preliminary calculation part B to be operated based on the result of detection by the first inspection part A, a second inspection part C to be operated for all the glass substrates of the one lot, and a defect determination part P to be operated based on the results of calculations by the preliminary calculation part B and the result of detection by the second inspection part C. Then, the result obtained by the defect determination part D is reflected in the downstream-side step. Therefore, the processes for one lot of the multi-sheet production glass, substrates 1 are all performed in the upstream-side step.

The above-mentioned first inspection part A is configured to detect a total number of defects present in ten or more multi-sheet production glass substrates 1 sampled from one lot of multi production glass substrates 1 based on defect data obtained by a defect inspection performed on the sampled multi-sheet production glass substrates 1, and to calculate a lot average defect density obtained by dividing the total number of defects by a total, area of surfaces as targets to be inspected. The “defect” herein means a defect at such a level that the defect becomes a problem in the downstream-side step.

The above-mentioned preliminary calculation, part 8 first calculates a profit received by an operator in the upstream-side step by preliminarily regarding the multi-sheet production glass substrate I having a defect in the one lot as a non-defective product and sending the multi-sheet production glass substrate 1 to the downstream-side step. The calculation is performed based on a unit price per multi-sheet production glass substrate in the upstream-side step and a yield (proportion of non-defective products) of the multi-sheet production glass substrates, which has the number of the defects present in single multi-sheet production glass substrate falling within a temporary allowable number of defects, the yield being calculated based on a lot average defect density. Subsequently, there is obtained a loss suffered by an operator in the downstream-side step in a case where each of the multi-sheet production glass substrates 1 preliminarily regarded as non-defective products is subjected to the product-related process (process of, for example, forming a film corresponding to a display screen or a circuit pattern on a surface of the multi-sheet production glass substrate 1) and is divided into a plurality of the individual-surface glass sheets 3. The calculation is performed based on a unit price per individual-surface glass sheet in a case where the multi-sheet production glass substrate 1 is subjected to the product-related process and is divided into the plurality of the individual-surface glass sheets 3 in the downstream-side step, and a yield of defective products as a result of the defects corresponding to the above-mentioned temporary allowable number of defects, which are sent to the downstream-side step to be contained in the individual-surface glass sheets 3, the yield being calculated based on the lot average defect density. Further, the preliminary calculation, part B preliminarily calculates the above-mentioned profit and loss over a plurality of times while differing the number of the defects present in the single multi-sheet production glass substrate described above, to thereby calculate an allowable number of defects of the defects present in the single multi-sheet production glass substrate in a case where the above-mentioned profit is larger than the above-mentioned loss (more preferably, the profit is the largest within the range of preliminary calculations) baaed on the results of preliminary calculations. Note that, the calculations of the preliminary calculation part B are performed by a computer.

The above-mentioned second inspection part C performs a defect inspection on all the multi-sheet production glass substrates 1 of the one lot, and counts through actual measurement the allowable number or defects of the defects present in the single multi-sheet production glass substrate 1 while matching the multi-sheet production glass substrate 1 with virtual lines defining the virtual individual surfaces 2 of the multi-sheet production glass substrate 1.

The above-mentioned defect determination part D determines, among the multi-sheet production glass substrates 1 of the one lot, the multi-sheet production glass substrate 1 including an actual number of the defects present in the single multi-sheet production glass substrate actually measured by the second inspection part C, which is equal to the true allowable number of the defects present in the single multi-sheet production glass substrate calculated by the above-mentioned preliminary calculation part B as a non-defective product to be sent to the downstream-side step in addition to the multi-sheet production glass substrate 1 with no defect. The other multi-sheet production glass substrate 1 is determined as a defective product to be discarded in the upstream-side step. Note that, the determinations of the defect determination part D are performed by a computer.

The procedure described above is described in detail referring to Steps S1 to S7 of the flowchart of FIG. 2. The flowchart is an illustration of the procedure of the process in the upstream-side step alone.

Step S1 corresponds to the first inspection part A. In this step, the defect inspection is performed on ten or more multi-sheet production glass substrates 1 sampled from one lot of ten or more multi-sheet production glass substrates 1, which are formed by the downdraw method or the float method and are subjected to a predetermined process, as targets so as to count a total number of defects. Then, the lot average defect density obtained by dividing the total number of defects by the total inspection area is calculated. Although an optical automatic defect detection device is used for the first inspection part A (also for the second inspection part C), the virtual lines defining the virtual individual surfaces 2 of the multi-sheet production glass substrate 1 are not required to be obtained in advance in the present invention.

In Step S2, when it is supposed that the inspected multi-sheet production glass substrate 1 is regarded as a non-defective product in the downstream-side step, a number i of the defects present in the single multi-sheet production glass substrate 1 is determined so as to sequentially increment one by one from sere. Then, in Step S3, for each of all the numbers i that are sequentially incremented, a cumulative profit received by the operator in the upstream-side step and a cumulative loss suffered by the operator in the downstream-side step are compared with each other. The term “cumulative” herein means a cumulative value of the profit and a cumulative value of the loss, which are calculated by sequentially incrementing i one by one for each time from zero. The profit is calculated based on a unit price per multi-sheet production glass substrate in the upstream-side step and a yield of the multi-sheet production glass substrates 1 with the number of defects present in the single multi-sheet production glass substrates 1 falling within the allowable number of defects, the yield being calculated, based on the lot average defect density. The loss is calculated based on a unit price per individual-surface glass sheet 3 after the multi-sheet production glass substrate is subjected to the product-related process and is divided into the plurality of individual-surface glass sheets in the downstream-side step, and a yield of the defective products as a result of the defects corresponding to the allowable number of defects, which are sent to the downstream-side step to be contained in the individual-surface glass sheets 3, the yield being calculated based on the lot average defect density. In each of the cases, the yield only needs to be stochastically calculated based on. the lot average defect density by an expression using a binomial cumulative distribution function.

In Step S4, when the cumulative profit Is larger than

the cumulative loss, the process proceeds to Step S5. When the cumulative profit is not larger than the cumulative loss, the process proceeds to Step S7. In Step S5, when the cumulative profit is the largest as compared with the results of the preliminary calculations performed so far among a series of preliminary calculations in which i is sequentially incremented one by one from zero, the process proceeds to Step S6. When the cumulative profit is not the largest as compared with the results of the preliminary calculations performed so far, the process proceeds to Step S8. In Step S6, after the value of i at the time is set as a temporary allowable number of defects (appropriate number of the defects present in the single multi-sheet production glass substrate), the process proceeds to Step S7. In Step S7, it is determined whether the yield in the upstream-side step is 100% or more (has reached 100%). When the yield is 100% or more, the process proceeds to Step S8. When the yield is less than 100%, the process returns to Step S2. In Step S8, the temporary allowable number of defects at the time is set as a final allowable number of defects (true allowable number of defects). Then, the process proceeds to Step S9.

Step S9 corresponds to the second inspection part C. In this step, an actual number of the defects present in the single multi-sheet production glass substrate 1 is calculated for all the multi-sheet production glass substrates 1 of the one lot. Then, the process proceeds to Step S10. Step S10 corresponds to the defect determination part D. In this step, non-defective products and defective products are discriminated from each other based on the actual number of the defects present in the single multi-sheet production glass substrate 1 and the true allowable number of defects.

With the completion of the operation described above, it becomes clear whether a case where the actual number of the defects present in the single multi-sheet production glass substrate 1 is only one is regarded as the non-defective product or even a case where the actual number of the defects present in the single multi-sheet production glass substrate 1 is two or three is regarded as the non-defactive product. Based on the result, all the multi-sheet production glass substrates are inspected and discriminated.

More specifically, for the profit and loss described above, when the multi-sheet production glass substrate 1 with no defect is divided into the eight individual-surface glass sheets 3 after being subjected to the product-related process as illustrated in FIG. 3 (a), FIG. 3 (b), and FIG. 3 (c), no profit and loss is generated due to a defect both on the upstream side and the downstream side. Therefore, the profit and loss in the present invention are both zero. On the other hand, in a case where the multi-sheet production glass substrate 1 is discarded as a defective product if the number of the defects present in the single multi-sheet production glass substrate 1 is even one, the loss corresponds to a total price of all the multi-sheet production glass substrates 1 regarded as the defective products. In the related-art system, the above-mentioned loss is regarded as a loss. In the present invention to be compared with the related-art system, however, the profit is determined regarding the loss as zero in such a case.

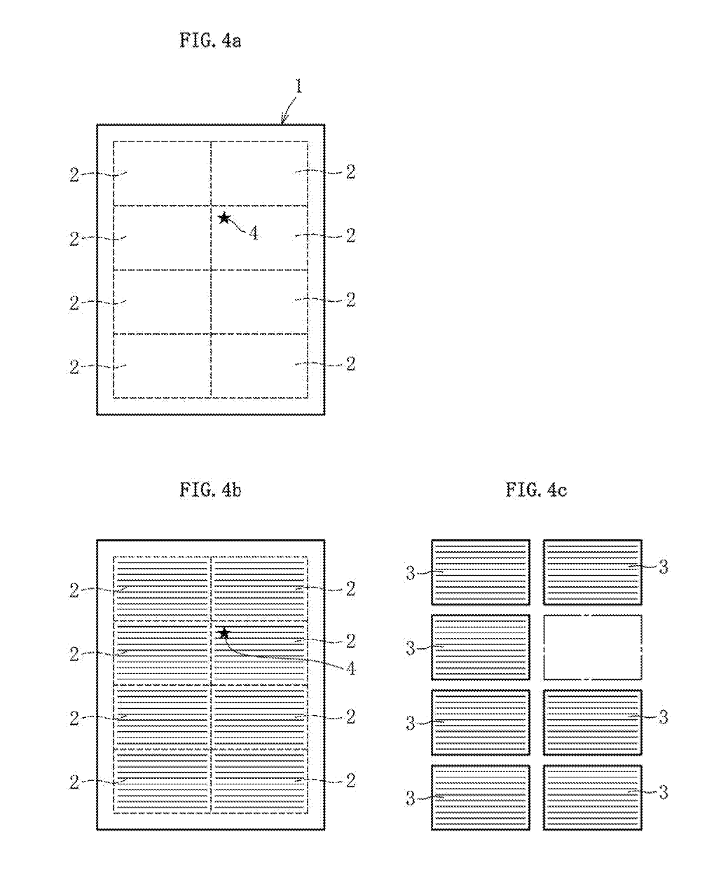

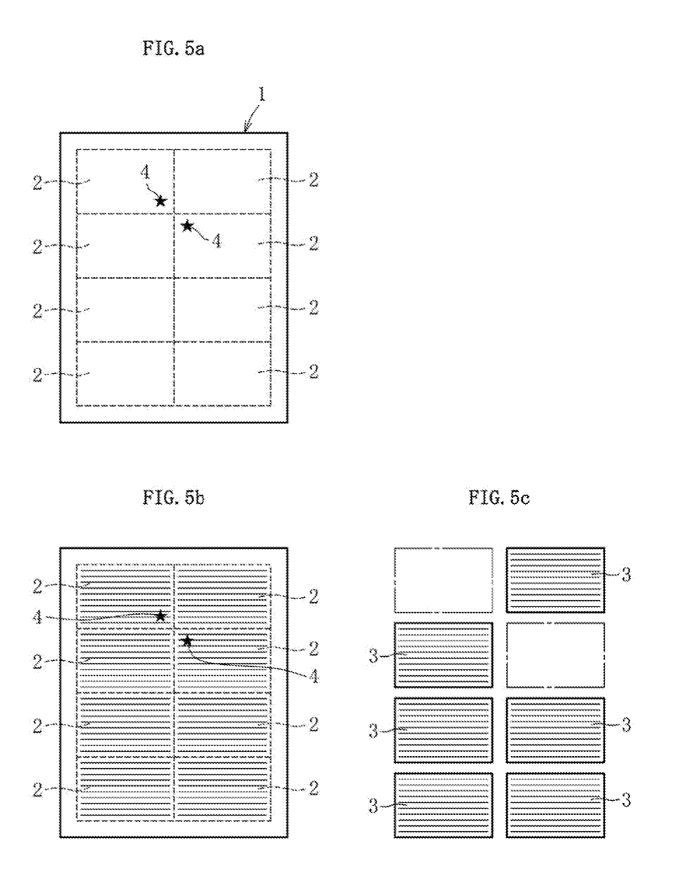

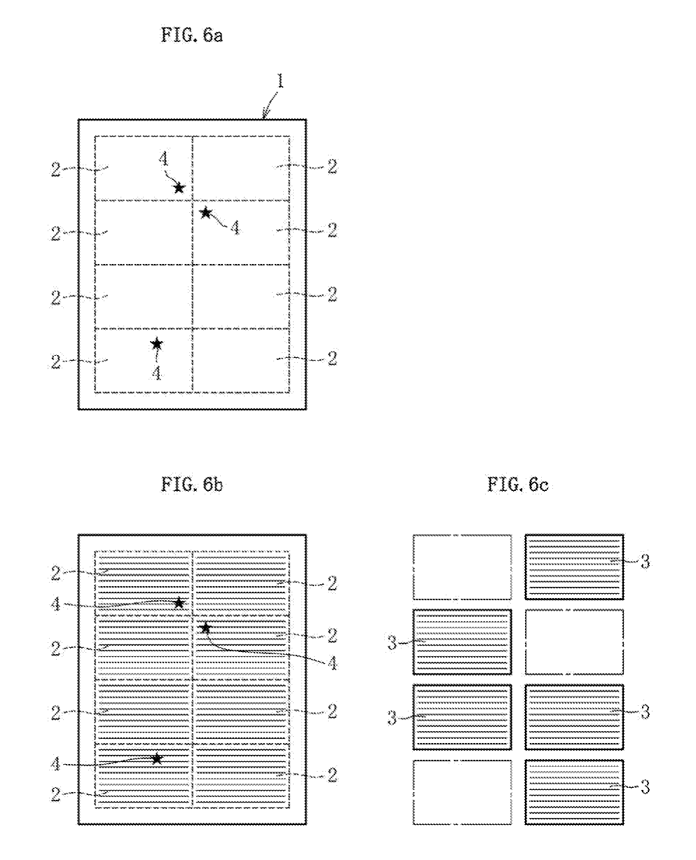

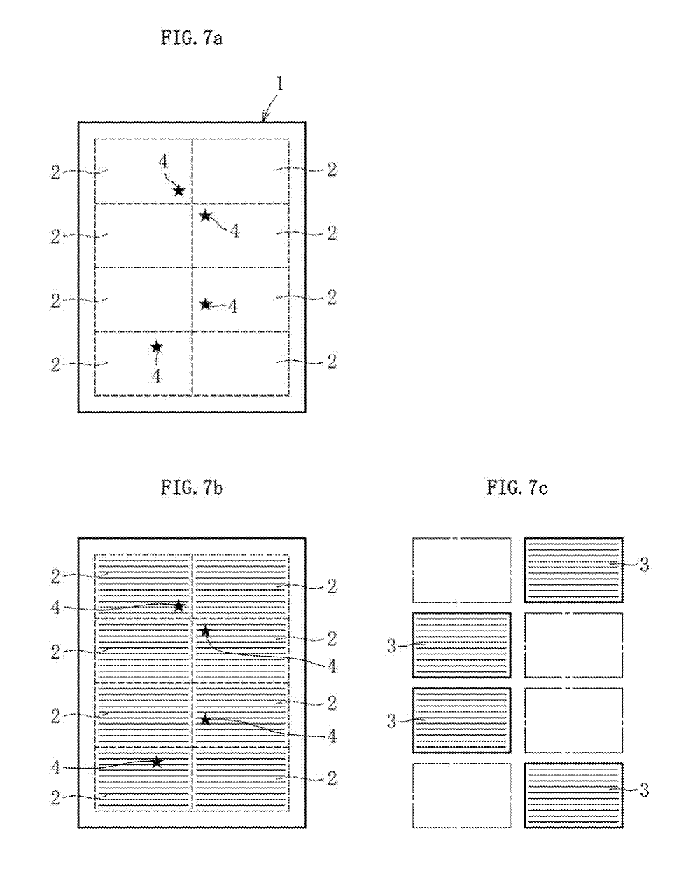

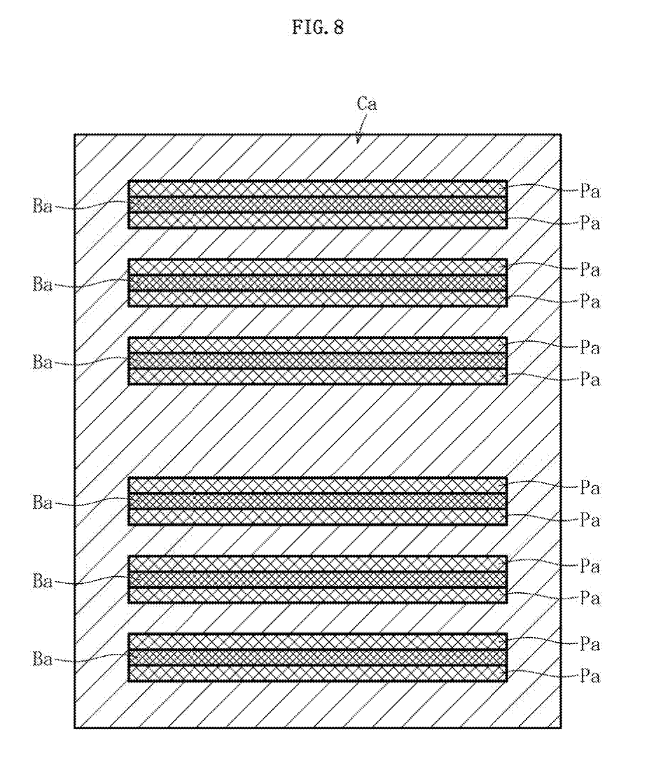

Then, as an example, it is assumed that the single multi-sheet production glass substrate 1 illustrated in FIG. 4 (a) includes one of the virtual individual surfaces 2 having one defect 4, the single multi-sheet production glass substrate 1 illustrated in FIG. 5 (a) includes two of the virtual individual surfaces 2 each having one defect 4, the single multi-sheet production glass substrate 1 illustrated in FIG. 6 (a) includes three of the virtual individual surfaces 2 each having one defect 4, and the single multi-sheet production glass substrate 1 illustrated in FIG. 7 (a) includes four of the virtual individual surfaces 2 each having one defect 4.

In this case, the first inspection part A only detects

a total number of the defects 4 (ten in this example) and divides the total number by the total area of the four multi-sheet production glass substrates 1 to calculate the lot average defect density. Then, in a process of the preliminary calculations performed by the preliminary calculation part B based on the lot average defect density, the profit obtained by regarding the multi-sheet production glass substrate 1 as a non-defective product in a stage previous to the production-related process as illustrated in FIG. 4(a) and the loss generated by discarding one individual-surface glass sheet 3 as illustrated in FIG. 4(c) after the product-related process is performed as illustrated in FIG. 4(b) are compared with each other. When the profit is larger than the loss, the multi-sheet production glass substrate 1 is sent from the upstream-side step to the downstream-side step as a non-defective product. Similarly, even for FIGS. 5, FIGS. 6, and FIGS. 7, the profit obtained by regarding the multi-sheet production glass substrate 1 in the stage previous to the product-related process as a non-defective product and the loss generated by discarding a corresponding number of the individual-surface glass sheets 3 after the manufacture-related process is performed are compared so as to determine whether or not the profit is larger than the loss. It is now assumed that the profit is larger than the loss for the multi-sheet production glass substrates 1 illustrated in FIGS. 4, FIGS. 5, and FIGS. 6 and the profit is not larger than the loss for that illustrated in FIGS. 7. Then, when the number of the defects present in the single multi-sheet production glass substrate 1 is one, two, or three, the multi-sheet production glass substrate 1 in the stage previous to the product-related process is sent from the upstream-side step to the downstream-side step, When the number is four or larger, the multi-sheet production glass substrate 1 in the stage previous to the product-related process is discarded in the upstream-side step.

The yield only needs to be stochastically calculated based on the above-mentioned lot average defect density by expressions using a binomial cumulative distribution function. A calculation in the embodiment, which includes the above-mentioned expressions, is described below. Expressions from [Expression 1]to [Expression 5], which, include the binomial cumulative distribution function, are used for the calculation. Definitions of parameters used in the expressions are listed in ladle 1. Among the parameters, parameters that serve as preconditions are listed in Table 2 in this embodiment. The results of the calculation by inputting the parameters are shown in Table 3.

$$\begin{matrix}Y ( N , m , d , E ) = {\sum }_{k = 0}^{m} ( \frac{N !}{k ! \cdot ( N - k ) !} \times {( d \times E )}^{k} \times {( 1 - d \times E )}^{N - k} ) & [ Expression 1 ] \\ Cp = Cap - Cbp = Cbp \times ( Y ( N , 0 , d , E ) - Y ( N , m , d , E ) ) & [ Expression 2 ] \\ Cs = Cas - Cbs = Cbs \times R \times ( 1 - α ) & [ Expression 3 ] \\ R = \frac{1}{N} \times {\sum }_{k = 1}^{m} ( k \times ( Y ( N , k , d , E ) - Y ( N , ( k - 1 ) , d , E ) ) ) & [ Expression 4 ] \\ - ( Cp + Cs ) > 0 & [ Expression 5 ]\end{matrix}$$

TABLE 1
DEFINITIONS OF PARAMETERS USED IN [EXPRESSION 1]
TO [EXPRESSION 5]

| | |
|---|---|
| N | Number of virtual individual surfaces formed in single |
| | multi-sheet production glass substrate (positive real |
| | number) |
| N₀ | N when E = E₀ |
| M | Allowable number of defects (0 or positive integer) |
| A | Effective area in single multi-sheet production glass |
| | substrate as target to be inspected (m²) |
| E | Area of virtual individual surface (m²) |
| E₀ | Small unit are, preferably E₀ = 0.00001 (m²) or less |
| | Note that, when E = E₀, N = N₀, = A/E₀ |
| D | Lot average defect density (number of defects/m²) |
| Y (N, m, d, E) | Yield (proportion of non-defective products) of multi- |
| | sheet production glass substrates calculated based on N, |
| | m, d, and E |
| R | Rate of virtual individual surfaces, each having defect |
| | (proportion of defective products) to all virtual individual |
| | surfaces manufactured by cutting non-defective multi- |
| | sheet production glass substrate inspected and |
| | discriminated under conditions of N, m, d and E in |
| | upstream-side step and sent to downstream-side step (%) |
| A | Harmless-region relief rate (%) |
| K | 0 or positive integer |
| Cbp | Cost per individual surface in upstream-side step when |
| | allowable number of defects is 0 |
| Cap | Cost per individual surface in upstream-side step when |
| | allowable number of defects is m |
| ΔCp | Gain per individual surface, which is enjoyed in |
| | upstream-side step when allowable number of defects is |
| | changed from 0 to m in upstream-side step (Cap-Cbp) |
| Cbs | Cost per individual surface in downstream-side step when |
| | allowable number of defects is 0 |
| Cas | Cost per individual surface in downstream-side step when |
| | allowable number of defects is m |
| ΔCs | Loss per individual surface, which is suffered in |
| | downstream-side step when allowable number of defects |
| | is changed from 0 to m in downstream-side step |
| | (Cas-Cbs) |

TABLE 2
CONDITIONS IN EMBODIMENT

| | | |
|---|---|---|
| N | 8 | |
| N₀ | 36480 | |
| M | Calculated for each of 0 to 5 | |
| E (m²) | 0.456 | |
| E₀ (m²) | 0.00001 | |
| d (Number of | 0.219 | |
| defects/m²) | | |
| Cbp (yen/surface) | 1,000 | |
| Cbs (yen/surface) | 3,000, 6,000, or 10,000 | |
| α (%) | 0 OR 40 | 40% is used only when |
| | | cost in downstream-side |
| | | step is 10,000 yen/surface |

TABLE 3

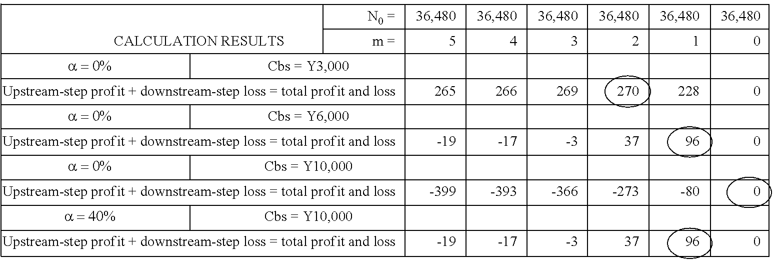

The harmless-region relief rate (α) used in the calculations is, for example, a rate of area replaced as a probability based on design information of a circuit pattern for a harmless region along a complex circuit pattern in which the multi-sheet production glass substrate is not regarded as being defective in an inspection for the circuit pattern even though there is a defect that is regarded as being defective in the upstream-side step based on design information such circuit pattern formed on the glass substrate in the downstream-side step.

According to Table 3, in a case where α is 0% and Cbs is 3,000 yen, the cumulative profit is the largest (270 yen) when the allowable number of defects is two in an eight-sheet production glass substrate, therefore, among the multi-sheet production glass substrates 1 of the one lot, the multi-sheet production glass substrates 1 including the actual number of the defects present in the single multi-sheet production glass substrate of one and two are sent from the upstream-side step to the downstream-side step together with the multi-sheet production glass substrates 1 with no defect. Further, in both of a case where α is 0% and Cbs is 6,000 yen and a case where α is 40% and Cbs is 10,000 yen, the cumulative profit is the largest (96 yen) when the allowable number of defects is one in the eight-sheet production glass substrate and the allowable number is one among eight virtual individual surfaces. Therefore, among the multi-sheet production glass substrates 1 of the one lot, the multi-sheet production glass substrate 1 including the actual number of the defects present in the single multi-sheet production glass substrate of one is sent from the upstream-side step to the down stream-side step together with the multi-sheet production glass substrates 1 with no defect. In a case where α is 0% and Cbs is 10,000 yen, the cumulative profit is always zero or smaller. Therefore, only the multi-sheet production glass substrate 1 with no defect of the one lot is sent from the upstream-side step to the downstream-side step.

The harmless-region relief rate (α) is now described in detail. As illustrated in FIG. 8, in a case where a plurality of linear circuit patterns Pa (roughly cross-hatched regions) are scheduled to be arranged in parallel on the multi-sheet production glass substrate 1, disconnection or short-circuit may occur if the circuit pattern Pa has a defect or a region Ba (finely cross-hatched region) in proximity to the circuit pattern Pa has a defect. Therefore, a region formed with Pa and Ba is defined as a harmful region in which the presence of a defect is not allowed, whereas another region Ca (region hatched with parallel diagonal lines) is defined as a harmless region. A value obtained by dividing the area of Ca by the area of a total region (effective surface region) of the multi-sheet production glass substrate 1 is defined as the harmless-region relief rate (α). This concept is preferably used fox the calculation in this embodiment. If a cannot be identified, however, the calculation only needs to be performed with α=0 substituted into the expression.

The production management system S according to the embodiment described above can determine whether the multi-sheet production glass substrate 1 is non-defective or defective only in the upstream-side step. Therefore, the defect information is not required to be conveyed from the operator in the upstream-side step to the operator in the downstream-side step. Thus, advantages are attained in terms of facility, inventory control, and production scheduling for products. Thus, an actual operation can be performed easily. Further, the defect inspection only needs the detection of the total number of defects so as to obtain the lot average defect density and the number of the defects 4 present in the single multi-sheet production glass substrate 1. Thus, a careful inspection for defects is not required to be performed in the upstream-side step. Inspection work for defects is remarkably simplified to improve operating efficiency. In addition, whether or not the multi-sheet production glass substrate 1 is non-defective or defective is determined in consideration of a total profit, and loss for the operator. In the upstream-side step and the operator in the downstream-side step. Thus, adverse effects, for example, unreasonable loss suffered by only any one of the operator in the upstream-side step and the operator in the downstream-side step, are not caused.

Note that, the operator in the upstream-side step may be a manufacturer of mother glass as the multi-sheet production glass substrate for a fiat panel display, and the operator in the downstream-side step may be an intermediate or final manufacturer of a panel for the flat panel display. Alternatively, the operator in the upstream-side step may be a manufacturer of mother glass as the multi-sheet product ion glass substrate for a flat panel display, and the operator in the downstream-side step may be a manufacturer who cuts and processes the mother glass for the flat panel display into the individual-surface glass sheets.

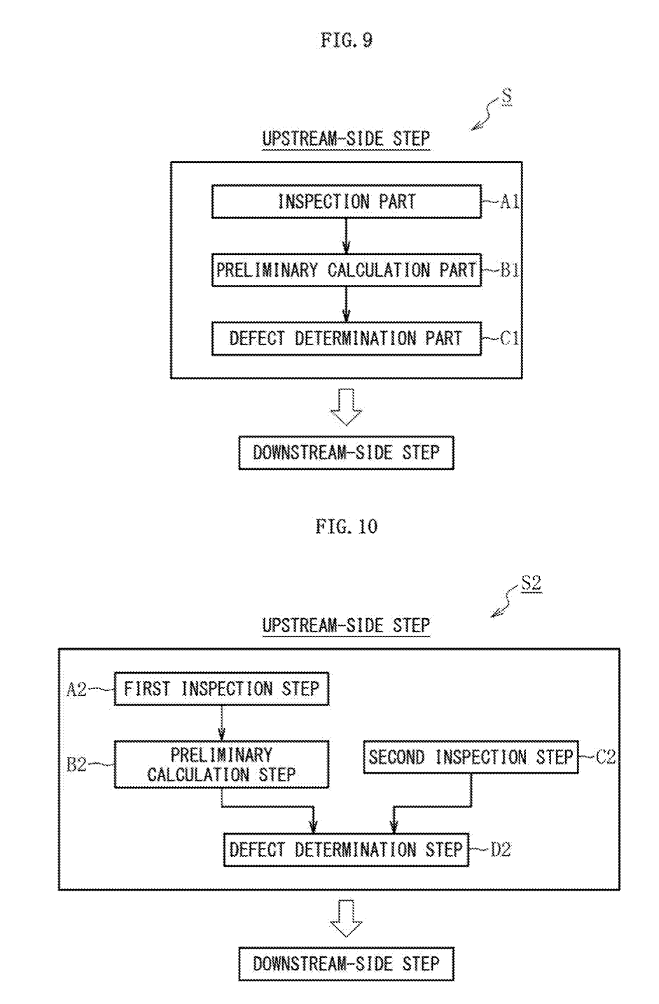

The first inspection part A, the preliminary calculation part B, the second inspection part C, and the defect determination part D in the embodiment described above may be operated substantially simultaneously in a continuous manner. Specifically, the following steps may be set. An optical automatic defect detection device, in which inspected items flow continuously, is used. In an inspection process, while an inspection is being per formed by a single inspection part A1, in such a way that both purposes are achieved as illustrated in FIG. 9, the result is immediately subjected to a process performed toy a preliminary calculation part S1 with a computer. A defect determination part C1 is immediately operated based on the result. Finally, the inspected item is discriminated. In this case, for the detection of the lot average defect density by the inspection part A1, a moving average in accordance with continuous introduction of ten or more items to be inspected only needs to be used.

Further, although the plurality of virtual individual surfaces formed in the single multi-sheet production glass substrate essentially have the same size, the virtual individual surfaces may have different sizes.

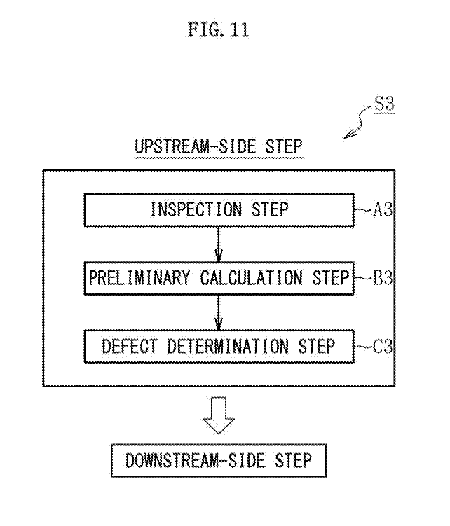

Although the present invention is applied as the glass substrate production management system S in the embodiment described above, as illustrated in FIG. 10, a glass substrate production management method S2 may include a first inspection step A2, a preliminary calculation step B2, a second inspection step C2, and a defect determination step D2. similarly, as illustrated in FIG. 11, a glass substrate production management method S3 may include a single inspection step A3, a preliminary calculation step 83, and a defect determination step G3. Even according to the glass substrate production management methods S2 and S3 described above, substantially the same process as that performed in the glass substrate production management system S described above is performed regardless of whether or not the entire process is performed by a computer.

The profit received by the operator in the upstream-side step and the loss suffered by the operator in the downstream-side step are calculated by using the binomial cumulative distribution function in the embodiment described above. The binomial cumulative distribution function is used on the premise that a defect probability distribution is a binomial distribution. Therefore, another distribution function that satisfies the premise may be used. The calculation technique of the present invention is not limited to that described above. Another calculation technique may be used as long as the profit received by the operator in the upstream-side step and the loss suffered by the operator in the downstream-side step can be calculated.

### REFERENCE SIGNS LIST

1 multi-sheet production glass substrates (mother glass)
2 virtual individual surface
3 individual-surface glass sheet
4 defect
A first inspection part
B preliminary calculation part
C second inspection part
S glass substrate production management system
A1 inspection part
B1 preliminary calculation part
C1 defect determination part
A2 first inspection step
B2 preliminary calculation step
C2 second inspection step
D2 defect determination step
S2 glass substrate production management method
A3 inspection step
B3 preliminary calculation step
C3 defect determination step
S3 glass substrate production management method

1-12. (canceled)

13. A system for managing production of glass substrates, comprising a procedure of performing a product-related process on multi-sheet production glass substrates manufactured in an upstream-side step to divide each of the multi-sheet production glass substrates into a plurality of individual-surface glass sheets in a downstream-side step, the glass substrate production management system comprising:
a first inspection part configured to detect a total number of defects present in ten or more multi-sheet production glass substrates sampled from one lot of ten or more multi-sheet production glass substrates in the upstream-side step based on defect data of a defect inspection performed on the sampled multi-sheet production glass substrates, and for calculating a lot average defect density obtained by dividing the total number of defects by a total area of the multi-sheet production glass substrates as targets to be inspected;
a preliminary calculation part configured to preliminarily calculate, for the one lot of the multi-sheet production glass substrates in the upstream-side step, a profit received by an operator in the upstream-side step by preliminarily regarding the each of the multi-sheet production glass substrates having the defect as a non-defective product and sending the each of the multi-sheet production glass substrates having the defect to the downstream-side step, and a loss suffered by an operator in the downstream-side step due to occurrence of a defective product caused by presence of the defect when the each of the multi-sheet production glass substrates preliminarily regarded as the non-defective product is divided into the plurality of individual-surface glass sheets after being subjected to the product-related process, over a plurality of times by using the lot average defect density while differing a number of the defects present in the single multi-sheet production glass substrate, and for calculating an allowable number of defects indicating an appropriate number of the defects present in the single multi-sheet production glass substrate based on results of the preliminary calculations when the profit is larger than the loss;
a second inspection part configured to perform a defect inspection on all the multi-sheet production glass substrates of the one lot in the upstream-side step to count an actual number of the defects present in the single multi-sheet production glass substrate; and
a defect determination part configured to determine the multi-sheet production glass substrates in which the actual number of the defects present in the single multi-sheet production glass substrate falls within a range of the allowable number of defects calculated by the preliminary calculation part as non-defective products to be sent to the downstream-side step in addition to the multi-sheet production glass substrates with no defect, and for determining other multi-sheet production glass substrates as defective products to be discarded in the upstream-side step.

14. A system for managing production of glass substrates, comprising a procedure of performing a product-related process on multi-sheet production glass substrates manufactured in an upstream-side step to divide each of the multi-sheet production glass substrates into a plurality of individual-surface glass sheets in a downstream-side step, the glass substrate production management system comprising:
an inspection part configured to detect a total number of defects present in ten or more multi-sheet production glass substrates sampled from one lot of ten or more multi-sheet production glass substrates in the upstream-side step based on defect data of a defect inspection performed on the sampled multi-sheet production glass substrates, to thereby calculate a lot average defect density obtained by dividing the total number of defects by a total area of the multi-sheet production glass substrates as targets to be inspected, and for performing a defect inspection on all the multi-sheet production glass substrates of the one lot to count an actual number of the defects present in the single multi-sheet production glass substrate;
a preliminary calculation part configured to preliminarily calculate, for the one lot of the multi-sheet production glass substrates in the upstream-side step, a profit received by an operator in the upstream-side step by preliminarily regarding the each of the multi-sheet production glass substrates having the defect as a non-defective product and sending the each of the multi-sheet production glass substrates having the defect to the downstream-side step, and a loss suffered by an operator in the downstream-side step due to occurrence of a defective product caused by presence of the defect when the each of the multi-sheet production glass substrates preliminarily regarded as the non-defective product is divided into the plurality of individual-surface glass sheets after being subjected to the product-related process, over a plurality of times by using the lot average defect density while differing a number of the defects present in the single multi-sheet production glass substrate, and for calculating an allowable number of defects indicating an appropriate number of the defects present in the single multi-sheet production glass substrate based on results of the preliminary calculations when the profit is larger than the loss; and
a defect determination part configured to determine the multi-sheet production glass substrates in which the actual number of the defects present in the single multi-sheet production glass substrate falls within a range of the allowable number of defects calculated by the preliminary calculation part as non-defective products to be sent to the downstream-side step in addition to the multi-sheet production glass substrates with no defect, and for determining other multi-sheet production glass substrates as defective products to be discarded in the upstream-side step.

15. The system for managing production of glass substrates according to claim 13, wherein a surface of the each of the multi-sheet production glass substrates to be subjected to the product-related process in the downstream-side step is divided into a harmful region, in which the defect is harmful to the product-related process, and a harmless region, in which the defect is harmless to the product-related process, to obtain, as a harmless-region relief rate, a value by dividing an area of the harmless region by an area of the each of the multi-sheet production glass substrates, and the harmless-region relief rate is used for the calculations performed by the preliminary calculation part.

16. The system for managing production of glass substrates according to claim 14, wherein a surface of the each of the multi-sheet production glass substrates to be subjected to the product-related process in the downstream-side step is divided into a harmful region, in which the defect is harmful to the product-related process, and a harmless region, in which the defect is harmless to the product-related process, to obtain, as a harmless-region relief rate, a value by dividing an area of the harmless region by an area of the each of the multi-sheet production glass substrates, and the harmless-region relief rate is used for the calculations performed by the preliminary calculation part.

17. The system for managing production of glass substrates according to claim 13, wherein the operator in the upstream-side step comprises a manufacturer of mother glass as the
each of the multi-sheet production glass substrates for a flat panel display, and the operator in the downstream-side step comprises an intermediate or final manufacturer of a panel for the flat panel display.

18. The system for managing production of glass substrates according to claim 14, wherein the operator in the upstream-side step comprises a manufacturer of mother glass as the each of the multi-sheet production glass substrates for a flat panel display, and the operator in the downstream-side step comprises an intermediate or final manufacturer of a panel for the flat panel display.

19. The system for managing production of glass substrates according to claim 13, wherein the operator in the upstream-side step comprises a manufacturer of mother glass as the each of the multi-sheet production glass substrates for a flat panel display, and the operator in the downstream-side step comprises a manufacturer who cuts and processes the mother glass for the flat panel display into the individual-surface glass sheets.

20. The system for managing production of glass substrates according to claim 14, wherein the operator in the upstream-side step comprises a manufacturer of mother glass as the each of the multi-sheet production glass substrates for a flat panel display, and the operator in the downstream-side step comprises a manufacturer who cuts and processes the mother glass for the flat panel display into the individual-surface glass sheets.

21. The system for managing production of glass substrates according to claim 13, wherein the calculating in the preliminary calculation part and the determining in the defect determination part are performed by a computer.

22. The system for managing production of glass substrates according to claim 14, wherein the calculating in the preliminary calculation part and the determining in the defect determination part are performed by a computer.

23. A method of managing production of glass substrates, comprising a procedure of performing a product-related process on multi-sheet production glass substrates manufactured in an upstream-side step to divide each of the multi-sheet production glass substrates into a plurality of individual-surface glass sheets in a downstream-side step, the method comprising:
a first inspection step of detecting a total number of defects present in ten or more multi-sheet production glass substrates sampled from one lot of ten or more multi-sheet production glass substrates in the upstream-side step based on defect data of a defect inspection performed on the sampled multi-sheet production glass substrates, and for calculating a lot average defect density obtained by dividing the total number of defects by a total area of the multi-sheet production glass substrates as targets to be inspected;
a preliminary calculation step of preliminarily calculating, for the one lot of the multi-sheet production glass substrates in the upstream-side step, a profit received by an operator in the upstream-side step by preliminarily regarding the each of the multi-sheet production glass substrates having the defect as a non-defective product and sending the each of the multi-sheet production glass substrates having the defect to the downstream-side step, and a loss suffered by an operator in the downstream-side step due to occurrence of a defective product caused by presence of the defect when the each of the multi-sheet production glass substrates preliminarily regarded as the non-defective product is divided into the plurality of individual-surface glass sheets after being subjected to the product-related process, over a plurality of times by using the lot average defect density while differing a number of the defects present in the single multi-sheet production glass substrate, and for calculating an allowable number of defects indicating an appropriate number of the defects present in the single multi-sheet production glass substrate based on results of the preliminary calculations when the profit is larger than the loss;
a second inspection step of performing a defect inspection on all the multi-sheet production glass substrates of the one lot in the upstream-side step to count an actual number of the defects present in the single multi-sheet production glass substrate; and
a defect determination step of determining the multi-sheet production glass substrates in which the actual number of the defects present in the single multi-sheet production glass substrate falls within a range of the allowable number of defects calculated by the preliminary calculation step as non-defective products to be sent to the downstream-side step in addition to the multi-sheet production glass substrates with no defect, and for determining other multi-sheet production glass substrates as defective products to be discarded in the upstream-side step.

24. A method of managing production of glass substrates, comprising a procedure of performing a product-related process on multi-sheet production glass substrates manufactured in an upstream-side step to divide each of the multi-sheet production glass substrates into a plurality of individual-surface glass sheets in a downstream-side step, the method comprising:
an inspection step of detecting a total number of defects present in ten or more multi-sheet production glass substrates sampled from one lot of ten or more multi-sheet production glass substrates in the upstream-side step based on defect data of a defect inspection performed on the sampled multi-sheet production glass substrates, to thereby calculate a lot average defect density obtained by dividing the total number of defects by a total area of the multi-sheet production glass substrates as targets to be inspected, and for performing a defect inspection on all the multi-sheet production glass substrates of the one lot to count an actual number of the defects present in the single multi-sheet production glass substrate;
a preliminary calculation step of preliminarily calculating, for the one lot of the multi-sheet production glass substrates in the upstream-side step, a profit received by an operator in the upstream-side step by preliminarily regarding the each of the multi-sheet production glass substrates having the defect as a non-defective product and sending the each of the multi-sheet production glass substrates having the defect to the downstream-side step, and a loss suffered by an operator in the downstream-side step due to occurrence of a defective product caused by presence of the defect when the each of the multi-sheet production glass substrates preliminarily regarded as the non-defective product is divided into the plurality of individual-surface glass sheets after being subjected to the product-related process, over a plurality of times by using the lot average defect density while differing a number of the defects present in the single multi-sheet production glass substrate, and for calculating an allowable number of defects indicating an appropriate number of the defects present in the single multi-sheet production glass substrate based on results of the preliminary calculations when the profit is larger than the loss; and
a defect determination step of determining the multi-sheet production glass substrates in which the actual number of the defects present in the single multi-sheet production glass substrate falls within a range of the allowable number of defects calculated by the preliminary calculation step as non-defective products to be sent to the downstream-side step in addition to the multi-sheet production glass substrates with no defect, and for determining other multi-sheet production glass substrates as defective products to be discarded in the upstream-side step.

25. The method of managing production of glass substrates according to claim 23, further comprising dividing a surface of the each of the multi-sheet production glass substrates to be subjected to the product-related process in the downstream-side step into a harmful region, in which the defect is harmful to the product-related process, and a harmless region, in which the defect is harmless to the product-related process, to obtain, as a harmless-region relief rate, a value by dividing an area of the harmless region by an area of the each of the multi-sheet production glass substrates, and using the harmless-region relief rate for the calculations performed in the preliminary calculation step.

26. The method of managing production of glass substrates according to claim 24, further comprising dividing a surface of the each of the multi-sheet production glass substrates to be subjected to the product-related process in the downstream-side step into a harmful region, in which the defect is harmful to the product-related process, and a harmless region, in which the defect is harmless to the product-related process, to obtain, as a harmless-region relief rate, a value by dividing an area of the harmless region by an area of the each of the multi-sheet production glass substrates, and using the harmless-region relief rate for the calculations performed in the preliminary calculation step.

27. The method of managing production of glass substrates according to claim 23, wherein the operator in the upstream-side step comprises a manufacturer of mother glass as the each of the multi-sheet production glass substrates for a flat panel display, and the operator in the downstream-side step comprises an intermediate or final manufacturer of a panel for the flat panel display.

28. The method of managing production of glass substrates according to claim 24, wherein the operator in the upstream-side step comprises a manufacturer of mother glass as the each of the multi-sheet production glass substrates for a flat panel display, and the operator in the downstream-side step comprises an intermediate or final manufacturer of a panel for the flat panel display.

29. The method of managing production of glass substrates according to claim 23, wherein the operator in the upstream-side step comprises a manufacturer of mother glass as the each of the multi-sheet production glass substrates for a flat panel display, and the operator in the downstream-side step comprises a manufacturer who cuts and processes the mother glass for the flat panel display into the individual-surface glass sheets.

30. The method of managing production of glass substrates according to claim 24, wherein the operator in the upstream-side step comprises a manufacturer of mother glass as the each of the multi-sheet production glass substrates for a flat panel display, and the operator in the downstream-side step comprises a manufacturer who cuts and processes the mother glass for the flat panel display into the individual-surface glass sheets.

31. The system for managing production of glass substrates according to claim 23, wherein the preliminary calculation step and the defect determination step are performed by a computer.

32. The system for managing production of glass substrates according to claim 24, wherein the preliminary calculation step and the defect determination step are performed by a computer.
